(19) United States
(12) Patent Application Publication
(10) Pub. No.: US 2020/0411891 A1
(43) Pub. Date: Dec. 31, 2020

(54) TANKS EMBODIMENT FOR A FLOW BATTERY

(71) Applicants: Angelo D'Anzi, Medicina (BO) (IT); Maurizio Tappi, Cesena (IT); Gianluca Piraccini, Cesena (IT); Carlo Alberto Brovero, Alexandria, VA (US)

(72) Inventors: Angelo D'Anzi, Medicina (BO) (IT); Maurizio Tappi, Cesena (IT); Gianluca Piraccini, Cesena (IT); Carlo Alberto Brovero, Alexandria, VA (US)

(21) Appl. No.: 16/498,403

(22) PCT Filed: Mar. 27, 2018
(86) PCT No.: PCT/US18/24512

§ 371 Date: Sep. 27, 2019

Related U.S. Application Data
(60) Provisional application No. 62/476,920, filed on Mar. 27, 2017.

(51) Int. Cl. H01M 8/18; H01M 8/04007; H01M 8/04082; H01M 8/04186; H01M 8/04276

(52) U.S. Cl. CPC H01M 8/188; H01M 8/04067; H01M 2220/10; H01M 8/04186; H01M 8/04276; H01M 8/04201

(57) ABSTRACT

A flow battery of the type comprising at least one stack of planar cells 17, at least one negative electrolyte tank 3, at least one positive electrolyte tank 4, at least two pumps 5 and 6, for supplying electrolytes to at least one stack of planar cells 17. Either or both of the first tank 3 and the second tank 4, a primary cabinet 19, an underground tanks container 20, having a thermal insulation 18 between said tanks container 20 and the tanks 3 and 4, at least one secondary heat exchanger 21, at least one primary heat exchanger 22, at least one coolant pump 23, wherein said container 20 is buried below ground level.

### TECHNICAL FIELD

The present invention relates to a flow battery, and particularly to a novel flow battery module in which the anolyte tank and the catholyte tank are buried below ground level so as to keep the electrolyte temperature in a safe range.

### BACKGROUND OF THE INVENTION

A flow battery is a type of rechargeable battery in which electrolytes that contain one or more dissolved electro-active substances flow through an electrochemical cell, which converts the chemical energy directly into electric energy. The electrolytes are stored in external tanks and are pumped through the cells of the reactor.

Flow batteries have the advantage of having a flexible layout (due to the separation between the power components and the energy components), a long life cycle, rapid response times, no need to smooth the charge and no harmful emissions.

Flow batteries are used for stationary applications with an energy demand between 1 kWh and several MWh: they are used to smooth the load of the grid, where the battery is used to accumulate during the night energy at low cost and return it to the grid when it is more expensive, but also to accumulate power from renewable sources such as solar energy and wind power, to then provide it during peak periods of energy demand.

In particular, a vanadium flow battery includes of a set of electrochemical cells in which the two electrolytes are separated by a proton exchange membrane. Both electrolytes are based on vanadium: the electrolyte in the positive half-cell contains V<4+> and V<5+> ions while the electrolyte in the negative half-cell contains V<3+> and V<2+> ions. The electrolytes can be prepared in several ways, for example by electrolytic dissolution of vanadium pentoxide (V2O5) in sulfuric acid (H2SO4). The solution that is used remains strongly acidic. In vanadium flow batteries, the two half-cells are furthermore connected to storage tanks that contain a very large volume of electrolyte, which is made to circulate through the cell by means of pumps.

While the battery is being charged, in the positive half-cell the vanadium is oxidized, converting V<4+> into V<5+>. The removed electrons are transferred to the negative half-cell, where they reduce the vanadium from V<3+> to V<2+>. During operation, the process occurs in reverse and one obtains a potential difference of 1.41V at 25° C. in an open circuit. The anolyte electrolyte and the catholyte electrolyte are stable in a limited temperature range typically between 0 to 50 Celsius. Outside this temperature range a precipitation of vanadium species will occur, no longer taking part in the battery reactions, losing storage capacity.

The vanadium flow battery is the only battery that accumulates electric energy in the electrolyte and not on the plates or electrodes, as occurs commonly in all other battery technologies.

Differently from all other batteries, in the vanadium Redox battery the electrolyte contained in the tanks, once charged, is not subjected to auto-discharge, while the portion of electrolyte that is stationary within the electrochemical cell is subject to auto-discharge over time.

The quantity of electric energy stored in the battery is determined by the volume of electrolyte contained in the tanks.

According to a particularly efficient specific constructive solution, a vanadium flow battery includes a set of electrochemical cells within which the two electrolytes, mutually separated by a polymeric membrane electrolyte. Both electrolytes are constituted by an acidic solution of dissolved vanadium. The positive electrolyte contains V<5+> and V<4+> ions, while the negative one contains V<2+> and V<3+> ions. While the battery is being charged, in the positive half-cell the vanadium oxidizes, while in the negatives half-cell the vanadium is reduced. During the discharge step, the process is reversed. The connection of multiple cells in an electrical series allows to increase the voltage across the battery, which is equal to the number of cells multiplied by 1.41 V.

During the charging phase, in order to store energy, the pumps are turned on, making the electrolyte flow within the electrochemical related cell. The electric energy applied to the electrochemical cell facilitates proton exchange by means of the membrane, charging the battery.

During the discharge phase, the pumps are turned on, making the electrolyte flow inside the electrochemical cell, creating a positive pressure in the related cell thus releasing the accumulated energy.

During the operation of the battery due to the internal resistance, the redox reactions generate heat. Said heat must to be dissipated in order to avoid reaching the limit of 50° C. as the critical temperature for which the Vanadium species dissolved in the electrolyte will precipitate to the bottom of the tank, no longer taking part in the redox reactions.

### BACKGROUND ART

FIG. 1 is a schematic view showing a conventional vanadium redox flow battery. As shown in FIG. 1, the conventional vanadium redox flow battery includes a plurality of positive electrodes 7, a plurality of negative electrodes 8, a positive electrolyte 1, a negative electrolyte 2, a positive electrolyte tank 3, and a negative electrolyte tank 4. The positive electrolyte 1 and the negative electrolyte 2 are respectively stored in tank 3 and tank 4. At the same time, the positive electrolyte 1 and the negative electrolyte 2 respectively pass through the positive electrode 7 and the negative electrode 8 via the positive connection pipelines and the negative connection pipelines to form the respective loops also indicated in FIG. 1 with the arrows. Pump 5 and pump 6 are often installed on the connection pipelines for continuously transporting the electrolytes to the electrode.

Moreover, a power conversion unit 11, e.g. a DC/AC converter, can be used in a vanadium redox flow battery, and the power conversion unit 11 is respectively electrically connected to the positive electrode 7 and the negative electrode 8 via the positive connection lines 9 and the negative connection lines 10, and the power conversion unit 11 also can be respectively electrically connected to an external input power source 12 and an external load 13 in order to convert the AC power generated by the external input power source 12 to DC power for charging the vanadium redox flow battery, or convert the DC power discharged by the vanadium redox flow battery to AC power for outputting to the external load 13.

FIG. 2 shows a schematic view of a conventional flow battery according to the state of the art, which includes in the dedicated cabinet 15 the entire flow battery as described in the FIG. 1 in order to maintain the battery in the safe temperature range, a thermal management device 14 is embedded.

The above-mentioned dedicated cabinet 15 is designed for outdoor installation. By means of thermal insulation 16, the cabinet 15 protects the battery from the harsh climate in the cool season and the heat coming from the sun irradiation during the warm season, whereas a thermal management device 14, 17 (which can be for example an air-conditioning unit or a simple heat exchanger communicating with a thermal sink) along with the pumps 5 and 6 as shown in FIG. 2, using the battery energy, will dissipate the heat when the temperature exceeds the maximum temperature limit, or alternatively will heat the battery in case of cold weather.

However, the disadvantages of the above-mentioned conventional flow battery according to the state of the art will cause a decrease in efficiency due to the power consumption of the thermal management device 14, 17 when operated in order to keep the battery within the ideal temperature range

An additional disadvantage of the above mentioned conventional flow battery according to the state of the art is that the size of the cabinet 15 is significant, precluding certain installations where the size is critical such as a telecom Tower or for residential homes.

Therefore, there is a need for providing a vanadium redox flow battery with improved thermal management in order to solve the problems presented by the conventional flow battery designs described above, to achieve improved efficiency and reliability and at the same time reducing the operating costs and shortening the payback period.

### SUMMARY OF THE INVENTION

As shown in FIG. 3, the objective of the present invention is to provide a vanadium redox flow battery module, having an innovative shape, which includes: at least one stack 17, at least one negative electrolyte tank 3, at least one positive electrolyte tank 4, at least two pumps 5 and 6, a primary cabinet 19, an underground container 20 for the tanks 3 and 4, the container 20 having a thermal insulation 18 between the container 20 and the tanks 3 and 4, at least one secondary heat exchanger 21, at least one primary heat exchanger 22, at least one coolant pump 23, wherein the container 20 is buried below ground level, while the primary cabinet 19 is to remain above ground level. The underground tank container 20 has an additional function also of acting as a spillage containment vessel.

The underground container 20 will be buried for example at 2 meters below ground level in order to capture the geothermal energy to keep the electrolyte temperature within the safe range as described in FIG. 4, minimizing the power consumption of the thermal management system. Meanwhile, in the present invention, the overall efficiency and reliability are increased due to the geothermal temperature stability. At 2 meters below ground level, ground temperature remains within the ideal range for the stability of vanadium flow batteries protecting the Battery Module from wide temperature fluctuations typical of an installation at surface level.

A further objective of the present invention is providing a flow battery that has small size, is relatively simple to put in operations and is safe to use.

### BRIEF DESCRIPTION OF THE DRAWINGS

Further characteristics and advantages of the invention will become better apparent from the description of a preferred but not exclusive embodiment of the flow battery according to the invention, illustrated by way of non limiting example in the accompanying drawings, wherein:

FIG. 1 is a schematic view showing a conventional vanadium flow battery;

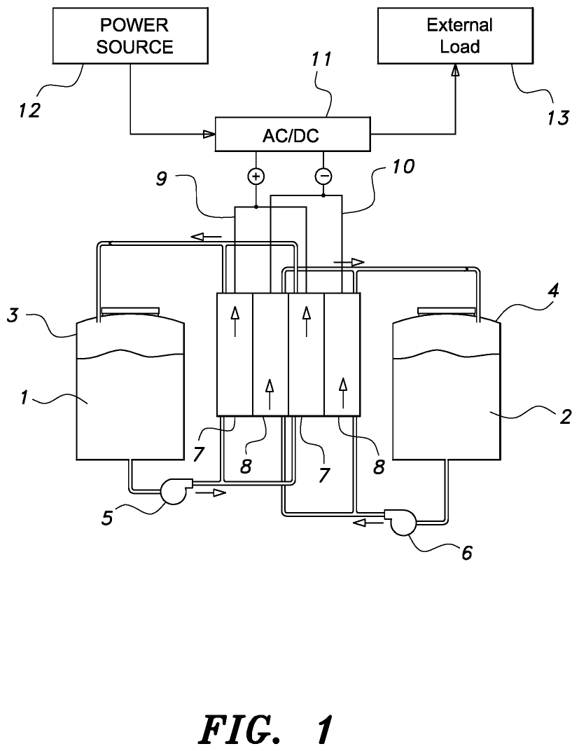

FIG. 2 is a schematic view of a flow battery module according to the state of the art;

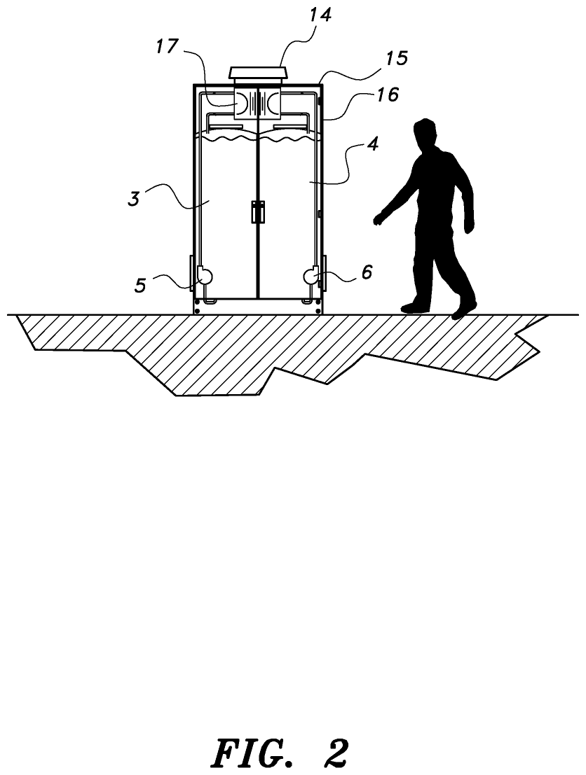

FIG. 3 is a schematic view of a vanadium flow battery according to the present invention;

FIG. 4 is a diagram showing an example of geothermal temperature throughout the year at different depths.

### DESCRIPTION OF EMBODIMENTS

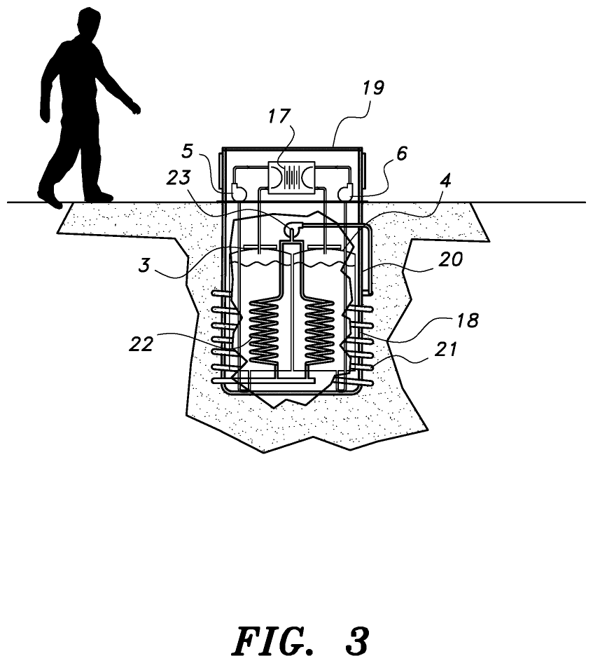

As shown in FIG. 3, the objective of the present invention is to provide a vanadium redox flow battery module, having an innovative shape, which includes: at least one stack 17, at least one negative electrolyte tank 3, at least one positive electrolyte tank 4, at least two pumps 5 and 6, a primary cabinet 19, an underground container 20 for the tanks 3 and 4, the container 20 having a thermal insulation 18 between the container 20 and the tanks 3 and 4, at least one secondary heat exchanger 21, at least one primary heat exchanger 22, at least one coolant pump 23, wherein the container 20 is buried below ground level, while the primary cabinet 19 is to remain above ground level. The underground tank container 20 has an additional function also of acting as a spillage containment vessel.

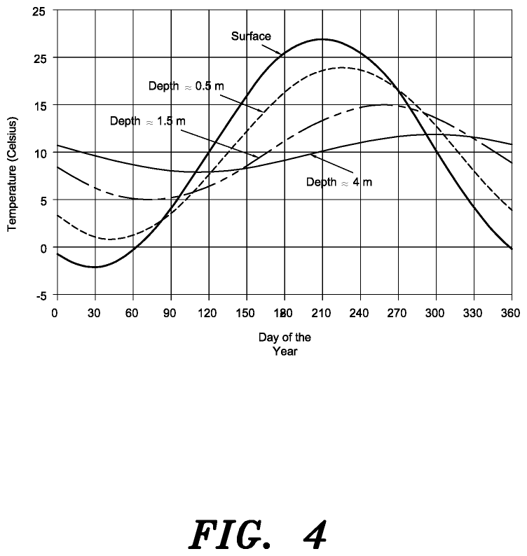

The underground container 20 will be buried for example at 2 meters below ground level in order to capture the geothermal energy to keep the electrolyte temperature within the safe range as described in FIG. 4, minimizing the power consumption of the thermal management system. Meanwhile, in the present invention, the overall efficiency and reliability are increased due to the geothermal temperature stability. At 2 meters below ground level, ground temperature remains within the ideal range for the stability of vanadium flow batteries protecting the Battery Module from wide temperature fluctuations typical of an installation at surface level.

A further objective of the present invention is providing a flow battery that has small size, is relatively simple to put in operations and is safe to use.

FIG. 4 depicts in general terms a diagram showing an example of ground temperature versus the day of the year for different depths. The thermal excursion, e.g. at 2 meters, is stable in the range comprised between 6 degrees Celsius in the cool season and 13 degrees Celsius in the warm season.

In the flow battery Module according to the present invention, the underground container 20 will be buried for example at 2 meters below ground level where the ground temperature excursion is more stable than the external environment such as the one described in FIG. 4, eliminating the peaks of temperature which require an energy consumption for the thermal conditioning.

In the flow battery module according to the present invention, the thermal insulation 18 respectively between the underground tanks container 20 and the two tanks 3 and 4, will keep the electrolyte tanks thermally insulated.

In the flow battery module according to the present invention, the secondary tubular heat exchanger 21 is placed all around the underground tanks container 20. The secondary tubular heat exchanger 21 may be made of low-cost plastic material such as Polypropylene or Polyethylene, and the secondary tubular heat exchanger is in direct contact with the ground, obtaining close to the best heat transfer and attempts to maximize efficiency.

In the flow battery module according to the present invention, the primary tubular heat exchanger 22 is placed inside both electrolyte tanks 3 and 4, in direct contact with the electrolyte. By a coolant pump 23, one side of the primary tubular heat exchanger is connected to one side of the secondary tubular heat exchanger 21, wherein the other sides of both the primary heat exchanger 22 and the secondary tubular heat exchanger 21 are reciprocally connected creating a single circuit. A glycol ethylene solution fills the inside of the heat exchanger circuit.

The flow battery module according to the present invention, in the case of a harsh climate, by means of the geothermal temperature transferred to the underground tanks container 20 will remain within an ideal temperature range between +5 degrees Celsius and +13 degrees Celsius.

The flow battery module according to the present invention, in case of a hot climate, will transfer heat from the underground tanks container 20 to the ground and remain within the ideal temperature range, as the heat produced by the reactions is dissipated by the ground by means of the heat exchanger circuit.

In the flow battery Module of the present invention, an additional advantage is constituted by the fact that the size is more compact than the conventional ones, wherein the tanks placed underground are also protected by potential damage derived by external hits or shots.

In the flow battery module of the present invention, an additional advantage is constituted by the fact that the underground tanks container 20 has an additional function acting as a spillage containment vessel.

Meanwhile, in the present invention, the overall efficiency and the reliability are increased by means of the geothermal temperature stability, which will remain within an ideal range for the safe storage of the electrolyte, minimizing the energy consumption of the thermal management device.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs. Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A flow battery, comprising: at least one stack 17, at least one negative electrolyte tank 3, at least one positive electrolyte tank 4; at least two pumps 5 and 6; a primary cabinet 19; an underground container for the tanks 20; a thermal insulation 18 between said tanks 3 and 4 and said container 20 and between said tanks 3 and 4; at least one secondary heat exchanger 21; at least one primary heat exchanger 22; at least one coolant pump 23; and wherein said underground tank container 20 is buried below ground level; and wherein said primary cabinet 19 is disposed above ground level.

2. The flow battery according to claim 1, wherein said primary cabinet 19 can be eliminated by placing all the components also underground, inside the underground tank container 20, allowing for an access on the ground surface.

3. The flow battery according to claim 1, wherein said underground tank container is placed at a certain depth where the temperature range is stable at a suitable level,

4. The flow battery according to claim 1, wherein the secondary heat exchanger can be of tubular shape or other cross sectional shape, is composed of relatively low-cost plastic material such as Polypropylene or Polyethylene, and wherein said secondary heat exchanger, of tubular shape or other cross sectional shape, is in directed contact with the ground, obtaining the best heat transfer maximizing the efficiency.

5. The flow battery according to claim 1 wherein the primary heat exchanger, of tubular shape or else, may be made of low-cost plastic material such as an example Polypropylene or Polyethylene, and is placed inside both the electrolyte tanks in direct contact with the electrolyte, obtaining the best heat transfer maximizing efficiency.

6. The flow battery according to claim 1 wherein a coolant pump in connected to one side of the primary heat exchanger, of tubular shape or other cross sectional shape, while the other side of the pump is connected to the secondary heat exchanger, of tubular shape or other cross sectional shape, wherein the other sides of both primary and secondary heat exchanger are reciprocally connected to each other creating a single circuit.

7. The flow battery according to claim 1 wherein a glycol ethylene or other anti freezing compound solution is used inside the heat exchanger circuit.

8. The flow battery according to claim 1 wherein the heat produced by the reactions is dissipated in the ground by means of the heat exchanger circuit.

9. The flow battery according to claim 1 wherein the size is more compact than a conventional one, whereas the tanks that are placed underground, are also protected by potential damage derived by external impacts.

10. The flow battery according to claim 1 wherein the underground tank container 20 has an additional function as a spillage containment vessel.
